(19) United States
(12) Patent Application Publication
(10) Pub. No.: US 2017/0131726 A1
(43) Pub. Date: May 11, 2017

(54) AUTOMATED OPERATION OF AIRCRAFT SYSTEMS IN INVERTED-V FORMATIONS

(71) Applicant: SySense Incorporated, El Segundo, CA (US)

(72) Inventors: Jason L. SPEYER, Los Angeles, CA (US); Jeff ELDREDGE, Los Angeles, CA (US)

(21) Appl. No.: 14/934,851

(22) Filed: Nov. 6, 2015

(51) Int. Cl. G05D 1/10; B64C 39/02

(52) U.S. Cl. CPC G05D 1/104; B64C 39/024; B64C 2201/143

(57) ABSTRACT

An aircraft system includes three or more aircraft and a flight control system. The flight control system controls flight of the aircraft so as to maintain the three aircraft in an inverted-V flight formation. Specifically, two leading aircraft fly along parallel flight paths and maintain substantially identical longitudinal positions along the parallel flight paths. A trailing aircraft flies along a flight path centered between the trailing vortices or flight paths of the leading aircraft and has a longitudinal position that is behind the two leading aircraft. The leading aircraft maintain a lateral separation distance such that the induced drag for the three aircraft formation is minimized for example by setting a lateral separation distance between wingtips of 0.8 to 1.0 wingspan of the trailing aircraft. The longitudinal separation between the leading and trailing aircraft is controlled by the flight control system based on operational objectives of the aircraft system.

### BACKGROUND

High altitude, long endurance (HALE) unmanned aerial systems (UAS) are aerial systems which are designed to be capable of flight at altitudes above commercial air traffic (e.g., above 30,000 feet) with extended range (e.g., infinite range). Such systems are commonly also called atmospheric satellites (or “atmosats”). The systems have a wide range of applications, including (but not limited to) surveillance, telecommunication, and earth observation. The systems can be used in certain applications as alternatives to conventional satellites at a fraction of the cost.

The conventional design for such systems is a single, solar-powered aircraft. Solar panels are typically mounted on the wings and other parts of the aircraft to harness energy from the sun to power the aircraft's electric motors. With this design paradigm, achieving long endurance flight requires very lightweight, high-aspect-ratio (long and slender) winged aircraft. Such designs commonly result in operational difficulties and structural and controllability concerns. The engineering trade-offs involved in the designs include structural strength, weight, aerodynamic lift, aerodynamic drag, thrust, and energy storage. These trade-offs are typical for any aircraft; however, for HALE UAS, the trade-offs are made stark by the severe restrictions faced by HALE aircraft on the limited amount of power that can be gathered through the solar panels and that is available for propulsion and powering on-board systems. As a result, solar-powered HALE vehicle are made to have long, slender, and high aspect ratio wings. However, the weight limitation forces the use of less material to build these long wings, almost to the point that the wings cannot support their own weight.

This disclosure address the problems outlined above by using multi-aircraft systems as HALE UAS, where the multi-aircraft systems are configured to fly the individual aircraft in precisely controlled formations to provide aerodynamic benefits to the individual aircraft and enable high altitude, long endurance flight.

### SUMMARY

The teachings herein alleviate one or more of the above noted problems by using multi-aircraft systems in which the aircraft fly in precisely controlled formations to provide aerodynamic benefits to the individual aircraft and enable high altitude, long endurance flight.

In accordance with the teachings, an aircraft system includes three aircraft operative to fly independently of each other and including two leading aircraft and a trailing aircraft. The aircraft system further includes a flight control system configured to control flight of the three aircraft and maintain the three aircraft in an inverted-V flight formation. The flight control system controls flight of the three aircraft such that the two leading aircraft fly along parallel flight paths and have substantially identical longitudinal positions along the parallel flight paths, and such that the trailing aircraft flies along a flight path centered between the trailing vortices or flight paths of the two leading aircraft and has a longitudinal position along the flight path that is behind the two leading aircraft.

The flight control system may control flight of the three aircraft such that the two leading aircraft maintain a lateral distance between wingtips of 0.8 to 1.0 wingspan of the trailing aircraft. The flight control system may further control flight of the three aircraft such that the trailing aircraft has a longitudinal position along the flight path that is between 0 and 10 wingspans behind the two leading aircraft.

The flight control system may be operative to monitor relative positions of the three aircraft, and to communicate flight control instructions for the three aircraft using wireless communication links between the aircraft. In some examples, the flight control system is further operative to receive, through the wireless communication links between the aircraft, data on the current status of each aircraft, and to control flight of the three aircraft based at least in part on the received data on the current status of each aircraft.

The trailing aircraft may have a higher weight than the leading aircraft. The trailing aircraft may carry a heavier payload than either of the leading aircraft.

The aircraft system may further include fourth and fifth aircraft operative to fly independently of each other and of the three aircraft. The flight control system may be further configured to control flight of the fourth and fifth aircraft, and in particular to control flight of the fourth and fifth aircraft such that the fourth and fifth aircraft fly along respective flight paths that are parallel to the flight paths of the two leading aircraft. In some examples, the flight control system may control flight of the fourth and fifth aircraft such that the fourth aircraft has a longitudinal position along its respective flight path that is identical to the longitudinal position of the two leading aircraft and such that the fifth aircraft has a longitudinal position along its respective flight path that is identical to the longitudinal position of the trailing aircraft. In other examples, the flight control system may control flight of the fourth and fifth aircraft such that the fourth and fifth aircraft have a same longitudinal position that is ahead of the two leading aircraft, and the flight paths of the fourth and fifth aircraft are disposed symmetrically about the flight path of the trailing aircraft.

In accordance with further teachings, a method is provided that includes receiving, in a flight control system operative to control flight of an aircraft system including at least three aircraft, relative position measurements of the at least three aircraft. Flight of the at least three aircraft is controlled based on the received relative position measurements so as to maintain the three aircraft in an inverted-V flight formation by controlling two leading aircraft of the at least three aircraft to fly along parallel flight paths and have substantially identical longitudinal positions along the parallel flight paths, and controlling a trailing aircraft of the at least three aircraft to fly along a flight path centered between the trailing vortices or flight paths of the two leading aircraft and have a longitudinal position along the flight path that is behind the two leading aircraft.

The controlling may include communicating, from the flight control system through wireless communication links between the aircraft, flight control instructions for the three aircraft.

The controlling may further include controlling the flight of the at least three aircraft such that the two leading aircraft maintain a lateral distance between wingtips of 0.8 to 1.0 wingspan of the trailing aircraft. In some examples, the controlling further includes controlling the flight of the at least three aircraft such that trailing aircraft has a longitudinal position along the flight path that is between 0 and 10 wingspans behind the two leading aircraft.

The method may further include changing an inter-aircraft spacing parameter of the inverted-V flight formation, and controlling flight of the at least three aircraft so as to place the three aircraft in the inverted-V flight formation having the changed inter-aircraft spacing parameter. In some examples, the inter-aircraft spacing parameter may be changed based on determining a change in an operating mode of the aircraft system, a change in environmental conditions affecting the aircraft system, a change in a battery charge level or rate of the aircraft system, or a change in a flight path or objective of the aircraft system. In the same or other examples, the changing of the inter-aircraft spacing parameter may include reducing a longitudinal spacing between the leading aircrafts and the trailing aircrafts to a spacing of less than 4.0 wingspans of the trailing aircraft. In further examples, the changing of the inter-aircraft spacing parameter may include increasing a longitudinal spacing between the leading aircraft and the trailing aircraft in response to entering an operating mode in which a payload of the trailing aircraft is active.

In accordance with other teachings, a flight control system is provided that is configured to control flight of three aircraft operative to fly independently of each other and to maintain the three aircraft in an inverted-V flight formation. The flight control system includes an aircraft monitor receiving relative position measurements of the three aircraft, a flight formation monitor determining inter-aircraft spacing parameters of a desired inverted-V flight formation for the three aircraft, and a flight controller. The flight controller controls flight of the three aircraft based on the relative position measurements received by the aircraft monitor so as to maintain the three aircraft in the desired inverted-V flight formation determined by the flight formation monitor by controlling two leading aircraft of the three aircraft to fly along parallel flight paths and have substantially identical longitudinal positions along the parallel flight paths, and controls a trailing aircraft of the three aircraft to fly along a flight path centered between the trailing vortices or flight paths of the two leading aircraft and have a longitudinal position along the flight path that is behind the two leading aircraft.

The flight formation monitor may determine a lateral inter-aircraft spacing parameter between wingtips of the two leading aircraft of 0.8 to 1.0 wingspan of the trailing aircraft for the desired inverted-V flight formation for the three aircraft.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A is a high-level schematic diagram of an illustrative aircraft system including three aircraft flying in an inverted-V formation.

FIG. 1B is a schematic diagram showing relative position measurements between aircraft of an aircraft system flying in an inverted-V formation.

FIGS. 2A-2D are plots showing experimental measurements of drag coefficients and angles of attack for different values of lateral and longitudinal separations between aircraft in inverted-V flight formations obtained through simulations.

FIG. 3A is a high-level block diagram of a flight control system that may be used in an aircraft system flying in an inverted-V formation.

FIG. 3B is a high-level block diagram illustratively showing a flight control system's wireless communication capabilities.

FIGS. 4A-4E are high-level functional flow diagrams showing various methods for controlling flights of aircraft systems in inverted-V formations.

FIGS. 5A and 5B are high-level schematic diagrams of illustrative aircraft systems including aircraft flying in inverted-V formations.

FIG. 6 is a simplified functional block diagram of a computer that may be configured, for example, to function as the flight control system in the system of FIG. 3A.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The above described limitations for a single HALE aircraft can be alleviated by flying several aircraft in a close and precisely controlled formation. Formation flight can provide aerodynamic benefits and other performance improvements to the individual aircraft in the formation such that HALE operation of the multi-aircraft system is possible. For example, the aircraft of the multi-aircraft system can be controlled in a flight formation in which wake vortices of two or more leading aircraft can be exploited to increase the lift experienced by a trailing aircraft. By precisely positioning the aircraft, the trailing aircraft can experience reduced induced drag by taking advantage of up-wash in the vortices of the leading aircraft. The trailing aircraft can therefore increase its potential range and payload capacity. The flight formation can also confer aerodynamic benefits and other performance improvements to the leading aircraft, as detailed further below.

The disclosure thus details various systems and methods that relate to aircraft systems that include three or more aircraft that are in communication with each other. The systems and methods maintain the aircraft in an inverted-V flight formation including at least two leading aircraft and at least one trailing aircraft flying in the wake turbulence of the leading aircraft. The aircraft systems monitor and maintain the relative position of the aircraft such that the two leading aircraft maintain a same altitude (within a margin of error), a same longitudinal position (within a margin of error) determined along a flight path, and a lateral spacing between wingtips on the order of one wingspan of the trailing aircraft. The aircraft systems further monitor and maintain the relative position of the aircraft such that the trailing aircraft maintains the same altitude (within the margin of error) as the leading aircraft, a longitudinal position (within a margin of error) behind the leading aircraft along the flight path, and a lateral position centered between wingtips of the leading aircraft. The aircraft systems can operate in different modes, and may thus adjust the longitudinal and lateral spacing of the aircraft based on a current operating mode.

In order to monitor and control the relative positions of the aircraft in the aircraft systems, the aircraft system includes a flight control system. The flight control system is designed to maintain a flight formation geometry between the three or more aircraft. The flight control system can be configured to maintain different flight formation geometries, including flight formation geometries that are selected based on a current operating mode of the aircraft system. The flight control system can maintain the flight formation geometry based on precise measurements of the relative positions of the three or more aircraft, based on measurements of wake vortices or other turbulence produced by aircraft in the formation, based on global positioning system (GPS) location information, based on maintaining a minimum angle of attack or pitch angle of the trailing aircraft, and the like.

Reference now is made in detail to the examples illustrated in the accompanying drawings and discussed below.

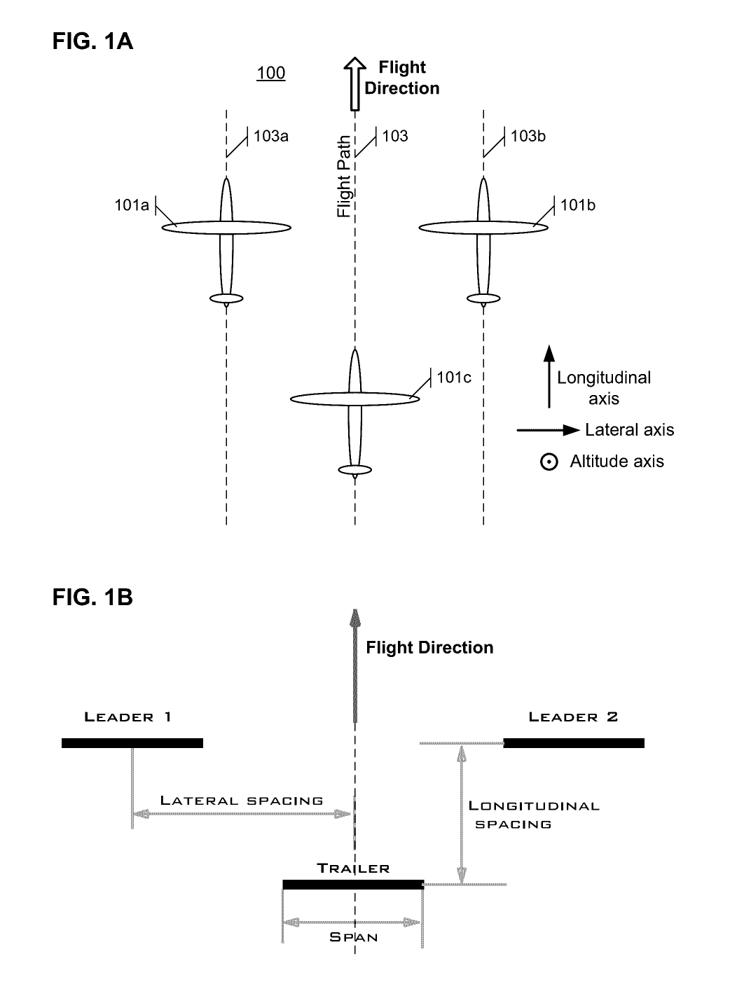

FIG. 1A shows one illustrative example of an aircraft system 100 including three aircraft 101a-c flying in an inverted-V flight formation. The aircraft system 100 includes two leading aircraft, 101a and 101b, that are positioned ahead of a trailing aircraft 101c along the flight path 103. As shown, the aircraft system 100 follows the flight path 103 along the flight direction identified in the figure. The flight path 103 shown in the figure is the path followed by a central point of the aircraft system 100, such as a center of mass of the aircraft system 100. The flight path 103 of the aircraft system 100 coincides with the flight path of the trailing aircraft 101c in the symmetrical inverted-V flight formation. Meanwhile, the leading aircraft 101a and 101b fly along respective parallel flight paths 103a and 103b that are symmetrically disposed about the flight path 103.

As shown in FIG. 1A, three directional axes are defined with respect to the aircraft system 100, its flight path 103, and flight direction. A longitudinal position axis measures the position of the aircraft along the direction of the flight path 103, such that a leading aircraft (e.g., 101a or 101b) has a larger/higher longitudinal position as compared to a trailing aircraft (e.g., 101c). A lateral position axis measures the position of the aircraft laterally with respect to the flight path 103 (and/or between the respective flight paths 103, 103a, and 103b). In the formation shown in FIG. 1A, the trailing aircraft (101c) is centered laterally with respect to the flight path 103, while the leading aircraft (101a, 101b) are positioned so as to be offset symmetrically and laterally on either side of the flight path 103. The third directional axis is the altitude axis. In general, the aircraft in a flight formation and in an aircraft system fly at the same (or substantially the same) altitude as each other, unless otherwise noted.

In the discussion to follow, various aircraft systems and flight formations will be described. FIG. 1B details some of the relative position measurements between aircraft in an aircraft system or flight formation. The aircraft's positions can be determined based on lateral spacing measured along the lateral position axis with respect to the flight path 103, and longitudinal spacing measured along the longitudinal position axis between leading and trailing aircraft. The lateral and longitudinal spacing are measured between positions of centers (e.g., centers of mass) of the different aircraft. The lateral spacing can also be measured between wingtips of adjacent aircraft (e.g., in reference to a distance between wingtips of the leading aircraft 101a and 101b). Further, relative spacing between aircraft can be measured in units of wingspan (or “span”) of the aircraft.

In general, all aircraft in an aircraft system have the same wingspan, and relative position measurements between the aircraft can be measured in units of the same wingspan. In some embodiments, however, leading and trailing aircraft can have different wingspans, and relative position measurements can be expressed in units of leading aircraft wingspans or trailing aircraft wingspans (where the leading aircraft have the same wingspan as each other).

As noted above, the aircraft system is operative to maintain the aircraft in an inverted-V flight formation including two or more leading aircraft and a trailing aircraft flying in the wake turbulence of the leading aircraft. In the three-aircraft embodiment of FIG. 1A, the aircraft system monitors and maintains the relative positions of the aircraft such that the two leading aircraft maintain a same altitude (within a margin of error), a same longitudinal position (within a margin of error) determined along the flight path, and symmetric lateral spacing determined with respect to the flight path 103 (such that flight paths 103a and 103b are symmetrically disposed about the flight path 103). The trailing aircraft has a lateral position centered on the flight path 103, and a longitudinal position relative to the leading aircraft that is controlled by the flight control system. The lateral spacing and longitudinal spacing parameters are selected to enhance the aerodynamic benefits conferred to the aircraft system, and can be selected based on the parameters disclosed below.

While the previous paragraph has described the aircraft system as maintaining the aircraft in an inverted-V flight formation based on relative positions of the aircraft, the aircraft system may control the positions of the aircraft based on the positions (or estimated positions) of wake vortices of the leading aircraft. In one example, the relative positions of the leading aircraft may be determined such that they maintain symmetric lateral spacing with respect to the flight path 103. Meanwhile, the position of the trailing aircraft may be determined based on the positions of wake vortices of the leading aircraft. For example, the trailing aircraft may maintain a position centered on the wake vortices of the leading aircraft. In conditions with little or no cross-wind, the trailing aircraft may thus maintain a lateral position substantially centered behind the two leading aircrafts (and thus on the flight path 103). However, in conditions in which a cross-wind or other disturbance occurs, the positions of the wake vortices of the leading aircraft may be affected. Under such conditions, the position of the trailing aircraft can be adjusted based on the positions (or estimated positions) of the trailing wake vortices so as to maintain the trailing aircraft in a particular position with respect to the trailing wake vortices. As such, if a cross-wind causes the trailing wake vortices to be offset in a downwind direction relative to the flight path 103, the trailing aircraft may be maintained at a position offset relative to the flight path 103 to as to remain centered on the trailing wake vortices of the leading aircraft. The positions of the wake vortices may be sensed using instrumentation in the trailing aircraft, or may be estimated based on the cross-wind direction and speed, based on the velocities of the leading aircraft, based on the longitudinal spacing of the leading and trailing aircraft.

The multiple aircraft (101a-c) of the aircraft system 100 can be identical or substantially identical aircraft. However, in some embodiments, the trailing aircraft 101c may be different from the leading aircraft 101a and 101b. In one example, the leading aircraft 101a and 101b are solar-powered aircraft that are substantially identical to each other, while the trailing aircraft 101c is configured to carry a payload (e.g., measurement instrumentation, a communication module, or the like). As a result, the trailing aircraft may have an overall weight (including the payload) that is higher than that of either of the leading aircraft. Further, the trailing aircraft 101c may have higher energy needs because the payload of the trailing aircraft 101c may rely on the aircraft's solar panels and batteries for operating power. In the example, the trailing aircraft 101c may therefore have a larger wingspan for mounting a larger area of solar panels and carrying a larger battery.

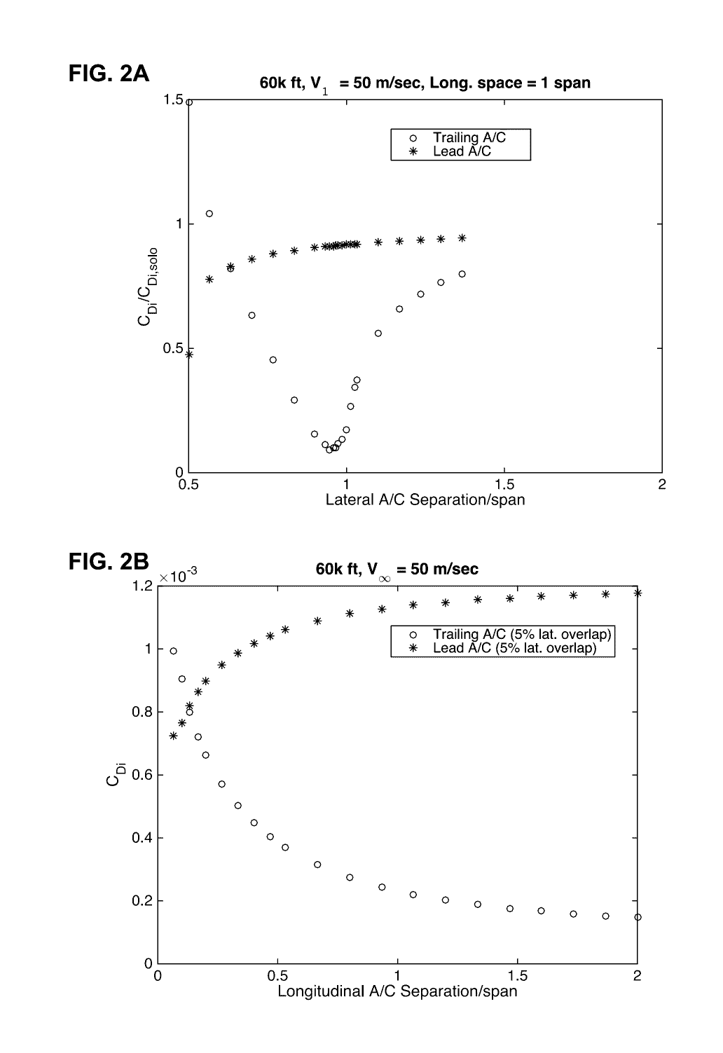

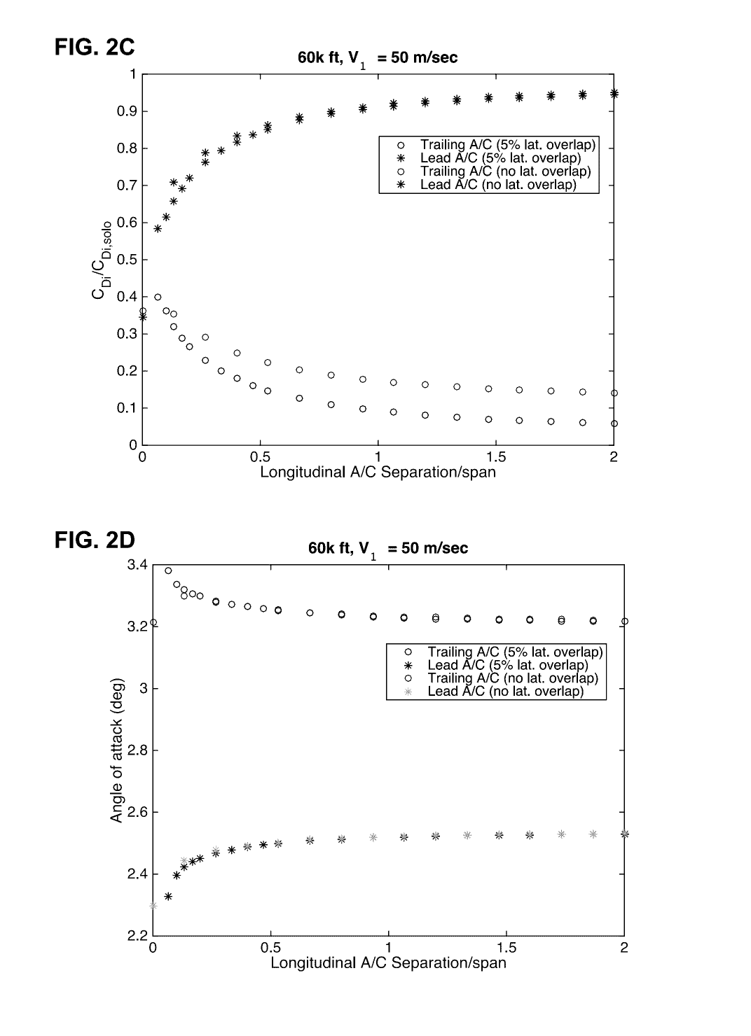

FIGS. 2A-2D show experimental measurements of normalized drag coefficients for different aircraft flight formations obtained through simulations. The measurements were developed for a three-aircraft inverted-V flight formation and provide normalized drag coefficients for different lateral spacings and longitudinal spacings (measured in units of wingspans). The measurements and associated teachings can be used to set spacing parameters in aircraft systems flying in inverted-V formations so as to attain desired aerodynamic benefits and lift distributions between aircraft in the formations.

The measurements of FIGS. 2A-2D were performed in an aircraft system in which each aircraft has a wingspan of 15 meters, a chord of 1 m; in which leading aircraft have weights of 60 kg and the trailing aircraft has a weight of 85 kg; in which the flight speed is 50 m/sec; and at an altitude of 18 km (59,000 ft).

FIG. 2A shows a plot of the induced drag in each lead aircraft (*) and the trailing aircraft (o) for different values of the lateral aircraft separation (plotted along the x-axis, and measured in units of wingspan). The induced drag C_{Di}, plotted against the y-axis, is normalized by the value of the induced drag for a solitary aircraft C_{Di,solo}. As shown in FIG. 2A, the induced drag in the trailing aircraft reaches a minimum for a lateral aircraft separation of approximately 0.95 wingspan. The measurements shown in FIG. 2A are for a longitudinal aircraft spacing of 1.0 wingspan. Hence, in order to maximally reduce the drag on the trailing aircraft in an inverted-V flight formation, the lateral spacing of each leading aircraft relative to the flight path can be set to 0.95 wingspan of the trailing aircraft (or within the range of [0.8-1.0] or [0.9-1.0] wingspans of the trailing aircraft). Note that this lateral spacing corresponds to a lateral spacing between wingtips of the leading aircraft of 0.95 wingspan (range: [0.8-1.0] or [0.9-1.0]) of the trailing aircraft.

Additionally, FIG. 2A shows that the normalized value of induced drag on the leading aircraft remains below 1.0, indicating that the leading aircraft maintain induced drag values that are no higher than those of an equivalent solitary aircraft. FIG. 2A further shows that the induced drag on the leading aircraft is reduced as the lateral spacing between the leading aircraft is reduced. Hence, in order to reduce the induced drag experienced by the leading aircraft, lateral spacing values of less than 0.8 or 0.9 wingspan (of the leading aircraft) can be selected. For example, the lateral spacing can be set within the range of [0.5-0.8] wingspan.

More generally, the lateral spacing can be set so as to minimize the total induced drag jointly experienced by all aircraft in the formation (e.g., the sum of the induced drag values experienced by each of the three aircraft in our simulated example). For this purpose, the lateral spacing can be set within a range of 0.9 to 1.0 wingspans; within a range of 0.8 to 1.0 wingspans; or within a range of 0.75 to 1.1 wingspans, for example.

FIG. 2B shows a plot of the induced drag in each lead aircraft (*) and the trailing aircraft (o) for different values of the longitudinal aircraft separation (plotted along the x-axis, and measured in units of wingspan). The measurements are performed for a lateral spacing between leading aircraft of 0.95 wingspans. As shown, the induced drag C_{Di} in the trailing aircraft is gradually reduced as the longitudinal aircraft separation is increased from a near zero separation value to a separation value of 2 wingspans. Further measurements (not shown) indicate that the low value of the induced drag remains constant at the low value for longitudinal separate values of 2 to 10 wingspans. Hence, in order to provide improved efficiency in the trailing aircraft, a longitudinal aircraft separation of 2 to 10 wingspans (e.g., 4 wingspans or less) can be used. Also, the induced drag experienced by the trailing aircraft increases for longitudinal aircraft separations below 2 wingspans (e.g., longitudinal aircraft separations at or below 1 wingspan).

However, as shown in FIG. 2B, the induced drag C_{Di} in each leading aircraft is gradually increased as the longitudinal aircraft separation is increased from a near zero value to a value of 2 wingspans. In particular, for longitudinal aircraft separations from the near zero value to a value of 0.8 wingspans, induced drag is reduced on the leading aircraft. Hence, in order to provide improved efficiency in the leading aircraft, the longitudinal aircraft separation can be set within the range [0.5-0.8] wingspans.

FIG. 2C provides a further plot of the induced drag in the leading and trailing aircraft for different values of lateral spacing; specifically, 0.95 and 1.0 wingspan spacing values are plotted. The induced drag is plotted for varying values of the longitudinal aircraft separation along the x-axis. As shown in the different dataset plotted in FIG. 2C, the trailing aircraft benefits from a noted reduction in induced drag when the lateral spacing between the leading aircraft is set to 0.95 wingspans (resulting in 5% overlap between flight paths of wingtips of the leading and trailing aircraft). The change in lateral spacing to the 0.95 value results in only a minimal increase in the induced drag affecting the leading aircraft.

Finally, FIG. 2D provides a plot of the angle of attack in the leading and trailing aircraft for varying values of the longitudinal aircraft separation (plotted along the x-axis) and for two values of lateral aircraft separation (plotted in the various data series). In accordance with the plot of FIG. 2D, the angle of attack of both the leading aircraft and the trailing aircraft may be adjusted based on the longitudinal aircraft separation in order to enhance the aerodynamic benefit conferred by the inverted-V flight formation.

In accordance with the teachings of FIGS. 2A-2D, at least two different sets of flight formation operating parameters can be established for the aircraft system 100. In both cases, lateral separation between wingtips of the leading aircraft is set to 0.95 wingspans (range: [0.8-1.0] or 0.9-1.0) of the trailing aircraft. In a first set of parameters, longitudinal separation between centers of mass of the leading and trailing aircraft is set below 1.0 wingspan of the trailing aircraft in order to reduce induced drag on the leading aircraft. For example, the longitudinal separation can be set within the range of 0.5-0.8 wingspans. In a second set of parameters, the longitudinal separation is set at or above 2.0 wingspans of the trailing aircraft (in the range of 2.0-10 wingspans) to reduce induced drag on the trailing aircraft.

In order to place the aircraft in the aircraft system 100 in the flight formation and maintain the aircraft in the formation, the aircraft system 100 includes a flight control system that acts as a formation flight controller. The flight control system is operative to monitor the relative positions of the aircraft in the aircraft system, and to control the flight path and flight controls of each of the aircraft to maintain the inverted-V formation. The flight control system can also control the flight path and flight controls of the aircraft in the aircraft system to change or adjust the flight formation, for example in response to the flight control system changing its current operating mode. The flight control system is further operative to establish a flight path for the aircraft system 100, and to control the aircraft system 100 to follow the established flight path while maintaining the flight formation.

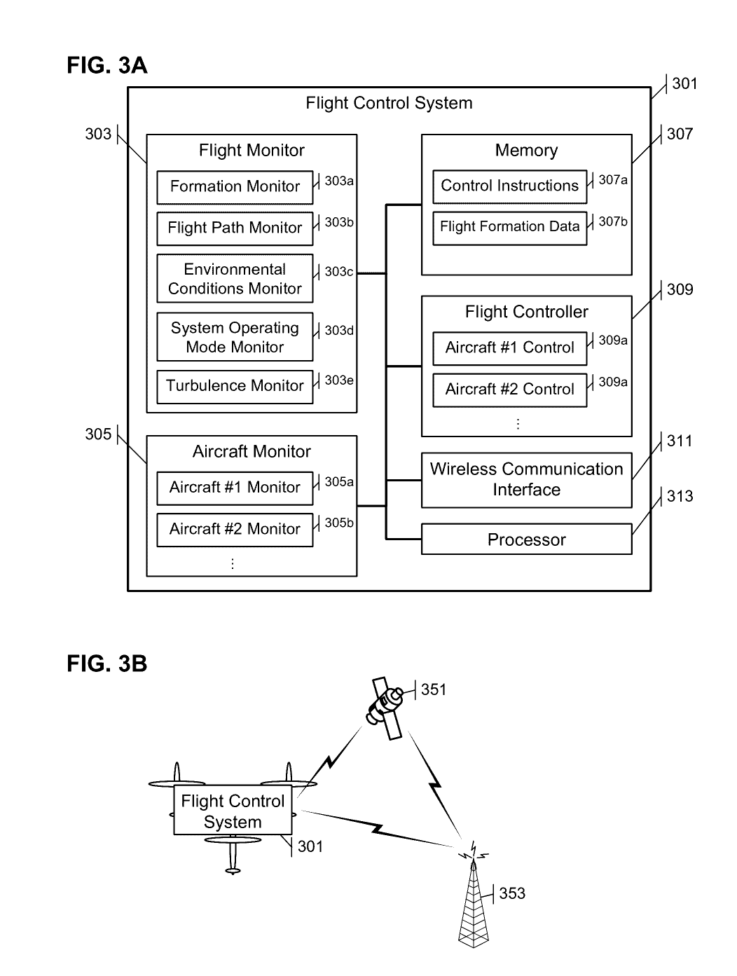

An illustrative flight control system 301 is shown in FIG. 3A. The flight control system 301 includes various components, including a flight monitor 303 operative to monitor the operation of the aircraft system 100, an aircraft monitor 305 operative to monitor the operation of individual aircraft of the aircraft system, a memory 307 storing control instructions and flight formation data, a flight controller 309 for controlling the operation of the aircraft of the system 100, a wireless communication interface 311, a processor 313, and a communications bus communicatively interconnecting the various components.

The aircraft monitor 305 is operative to monitor the operation of each individual aircraft of the aircraft system 100. The monitoring of the individual aircraft can include monitoring absolute and/or relative position, velocity, acceleration, and angular velocity of each aircraft in three dimensional space. The monitoring can also include monitoring of other aspects of aircraft operation, including monitoring of the aircraft's flight controls such as thrust levels, aileron positions, battery (or fuel) levels, battery charging or discharging status or rate, battery capacity and solar generation capacity, temperature, or the like.

For the purpose of aircraft monitoring, the aircraft monitor 305 is generally communicatively connected with each of the aircraft in the aircraft system 100 through wireless communication links. In such embodiments, an individual aircraft monitor 305a, 305b, etc., may be located in each aircraft, monitor operation of the corresponding aircraft, and report the monitored operation to a central aircraft monitor 305 that communicates with the flight monitor 303. The aircraft monitor 305 can be communicatively connected through a direct wireless communication link with each aircraft, or through a networked communication link between the aircraft (e.g., in embodiments in which aircraft are communicatively connected through a wireless network such as a mesh network). The communications can be direct aircraft-to-aircraft communications between aircraft of the aircraft system 100, or communication through a central hub or communication center such as a satellite (e.g., at 351 in FIG. 3B), ground control station (e.g., at 353 in FIG. 3B), or the like.

In other embodiments, the aircraft monitor 305 does not require communication connections between aircraft. In all embodiments, the aircraft monitor 305 is operative to measure the relative positions of aircraft in the aircraft system 100 using one or more of a laser range finder, RADAR, LiDAR, or the like. The aircraft monitor 305 may be mounted in or form part of one aircraft in the aircraft system 100, and may measure the positions of other aircraft relative to the one aircraft. The aircraft monitor 305 may further include inertial sensors to monitor the velocity and attitude of the one aircraft.

The flight monitor 303 monitors the operation of the aircraft system 100 based in part on data received from the aircraft monitor 305. For this purpose, the flight monitor 303 includes a formation monitor 303a that monitors the current flight formation of the aircraft system 100 based on the data received from the aircraft monitor 305. The formation monitor 303a determines the current flight formation by computing the relative positions of the aircraft of the aircraft system 100 based at least in part on position information obtained by the aircraft monitor 305. The formation monitor 303a can also use velocity information, thrust information, and the like as part of determining the current flight formation of the aircraft system 100. The formation monitor 303a also determines the optimal (or other desired) flight formation for the aircraft system 100, as described in further detail below, and determines whether the current flight formation differs from the desired flight formation.

The flight monitor 303 also includes a flight path monitor 303b. The flight path monitor 303b establishes the flight path for the aircraft system 100, and ensures that the flight control system 301 follows the established flight path. The flight path may be established to perform a particular function (e.g., perform a grid-scan of an area) or attain a particular objective (e.g., reach a particular location, climb to a particular altitude, descend to a particular altitude, or the like).

The flight control system 301 further includes an environmental conditions monitor 303c, a system operating mode monitor 303d, and a turbulence monitor 303e. Both the environmental conditions monitor 303c, the system operating mode monitor 303d, and the turbulence monitor 303e may provide data or information that is used to select or establish the flight formation and flight path followed by the flight control system 301. For this purpose, the environmental conditions monitor 303c (e.g., an air data suite) monitors conditions including wind conditions, and provides the monitored environmental conditions information to the formation monitor 303a and the flight path monitor 303b such that the formation and flight path can be established or adjusted based on current environmental conditions. For example, the flight formation and flight path may be adjusted in order to take advantage of current wind conditions or not to be hindered by current wind conditions. The environmental conditions monitor 303c also monitors conditions including daylight/night conditions. The monitoring of daylight/night conditions may notably be used in solar-powered aircraft systems 100 to establish or adjust flight formations and flight paths based on the daylight hours during which power is available from solar cells and based on each aircraft's battery charge. The environmental conditions monitor 303c can monitor additional environmental conditions, including predicted sunshine information that is computed by the environmental conditions monitor (e.g., based on remaining daylight hours, angle of incidence of sunlight, and the like) or received from an external data source (e.g., via the wireless communication interface 311 from a satellite, ground control, or other data source).

The system operating mode monitor 303d is used to select a current operating mode of the aircraft system 100. In this regard, the aircraft system 100 may be configured to operate in different operating modes. Operation of the aircraft system 100 can then be optimized for operation in the currently selected operating mode. For example, the system may operate in a climbing mode when the operational objective is to gain altitude (e.g., after take-off of the aircraft system 100, or at times when the aircraft system 100 needs to gain altitude to avoid a weather-pattern, a mountain range or other geographical obstacle, or the like) so as to store potential energy during the day when solar energy is available. Conversely, the system may operate in a descent or landing mode in other situations. The system may further operate in a directed mode when the operational objective is to reach a particular destination or fly through a series of beacons or waypoints. The system may further have distinct daytime and nighttime operating modes configured to optimize operation based on whether energy is currently available from solar panels. Additionally, the system may have a payload operating mode in which the aircraft system 100 operates when significant power from the batteries and/or solar panels of one or more aircraft (e.g., typically the trailing aircraft) is required to power the aircraft system's payload (e.g., instrumentation carried by the trailing aircraft). The aircraft system's current operating mode, as established by the system operating mode monitor 303d, is communicated to the formation monitor 303a and flight path monitor 303b such that the flight formation and flight path can be established or adjusted based on the current operating mode.

The turbulence monitor 303e is an optional component of the flight monitor 303, and can be used to sense the wake turbulence of the aircraft flying in formation. In particular, the turbulence monitor 303e may be located in the trailing aircraft (e.g., 101c), and may monitor the wake turbulence from the leading aircraft (e.g., 101a and 101b) that the trailing aircraft experiences. Based on the sensing and monitoring of the wake turbulence by the turbulence monitor 303e, the formation monitor 303a may then adjust the current formation of the aircraft system 100 to improve the aerodynamic benefit conferred to the individual aircraft. While the turbulence monitor 303e is described above as being located in the trailing aircraft (e.g., 101c), the turbulence monitor 303e can be distributed across multiple aircraft or be located in alternate locations such as in one or both of the leading aircraft. The turbulence monitor 303e may take the form of a sensor mounted on the nose cone of the aircraft, sensors mounted on leading or trailing edges of aircraft wings, or sensors mounted in other appropriate locations.

In general, the flight formation and flight path can be established directly and automatically by the flight control system 301 (and by the formation monitor 303a and flight path monitor 303b) based on programming instructions stored in the memory 307. The flight formation and flight path are then established and adjusted by the formation monitor 303a and flight path monitor 303b based on information received from the aircraft monitor 305, and environmental conditions monitor 303c, the system operating mode monitor 303d, and the turbulence monitor 303e. In some instances, however, flight path and/or flight formation information can be received from an external source such as a ground control station or a satellite (e.g., via wireless communication interface 311). In such instances, the flight formation and/or flight path can be adjusted to correspond to the received path and/or formation information.

The memory 307 stores various programming instructions in a non-transitory machine readable storage medium, including control instructions 307a used to establish and adjust flight formations and flight paths based on monitored aircraft, environmental, and turbulence conditions and on operating mode. The memory additionally stores flight formation data 307b that is used by the flight formation monitor 303a to establish the aircraft system's 100 current flight formation. The flight formation data includes data on various flight formations for the aircraft system 100, including parameters for adjusting the flight formation for increased efficiency during daytime vs. nighttime operation, for reducing the energy expended in the trailing aircraft, or the like. The flight formation data typically includes lateral spacing and longitudinal spacing data, for example, for establishing the proper spacing between the aircraft in formation.

Finally, the flight control system 301 includes a flight controller 309 operative to control the operation of the aircraft of the aircraft system 100. The flight controller 309 operates based on the flight monitoring performed by the flight monitor 303. Specifically, the flight controller 309 controls flight of the individual aircraft to fly in the formation established by the formation monitor 303a and to follow the flight path established by the flight path monitor 303b. The flight controller 309 includes individual controllers 309a, 309b, . . . for each of the aircraft in the system 100, and controls the individual controllers in coordinated fashion to ensure gradual and safe adjustments to each aircraft's flight.

The flight control system 301 will generally be distributed at least in part across the aircraft of the aircraft system 100. For example, the individual aircraft flight controllers 309a, 309b, . . . may include components located in the individual aircraft and operative to control flight operations of the aircraft in accordance with instructions received from the flight controller 309. The aircraft may thus be in wireless communication with each other, and may communicate flight control instructions from the flight controller 309 to each of the aircraft. Additionally, in embodiments in which the aircraft are in wireless communication with each other, the individual aircraft monitors 305a, 305b, . . . will generally include components located in the individual aircraft and operative to monitor operation of the aircraft and report monitored parameters back to the aircraft monitor 305.

Nonetheless, even in embodiments in which portions of the flight control system 301 are distributed across the aircraft, the flight control system 301 is generally centralized in one of the aircraft. Specifically, the flight path monitoring is generally performed in only one of the aircraft, and instructions from the controller 309 of that one aircraft are communicated to each of the other aircraft in the system 100 to ensure that the aircraft follow the established flight path and flight formation.

Additionally, as shown in FIG. 3B, the flight control system 301 can be in wireless communication with various other systems. For example, the flight control system 301 can be in communication with one or more communication satellites 351 or ground control stations 353, and may receive from the communication satellites 351 and/or ground control stations 353 flight control instructions information on environmental conditions, control instructions, or the like. Additionally, the flight control system 301 may be in communication with one or more global positioning system (GPS) satellites, and may use the signals received from such satellites to determine the locations of the aircraft in the aircraft system 100.

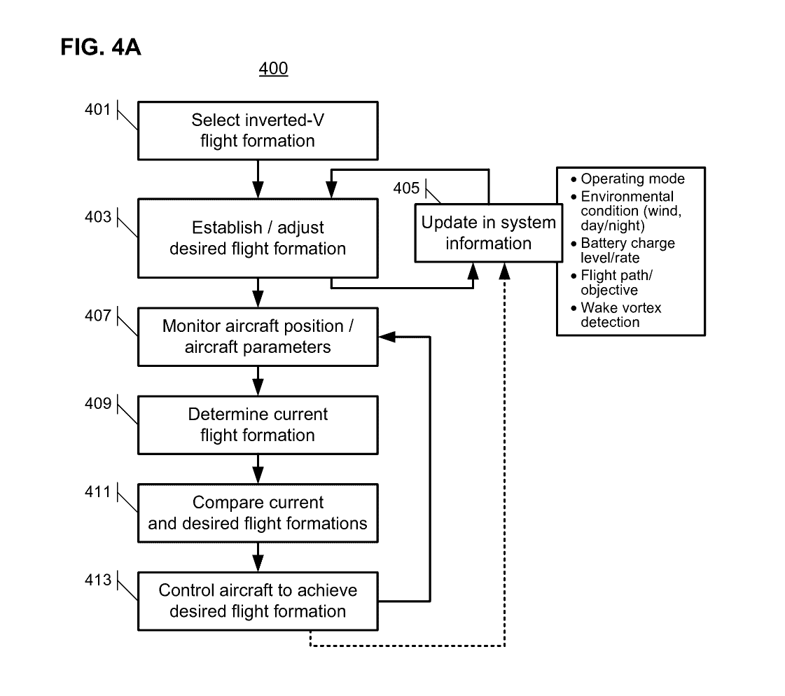

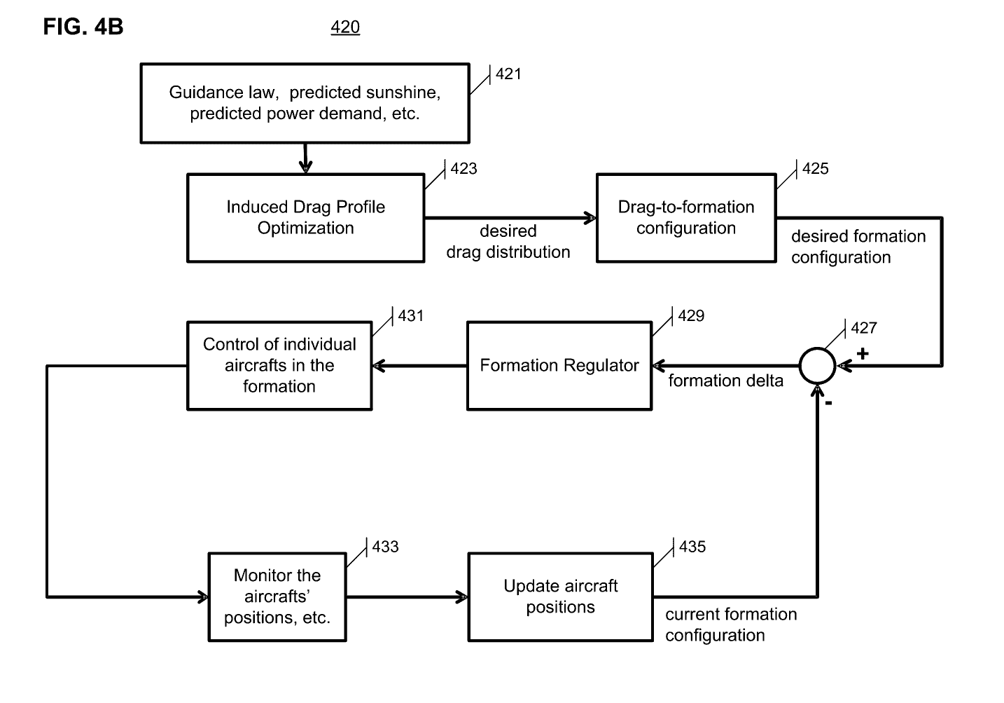

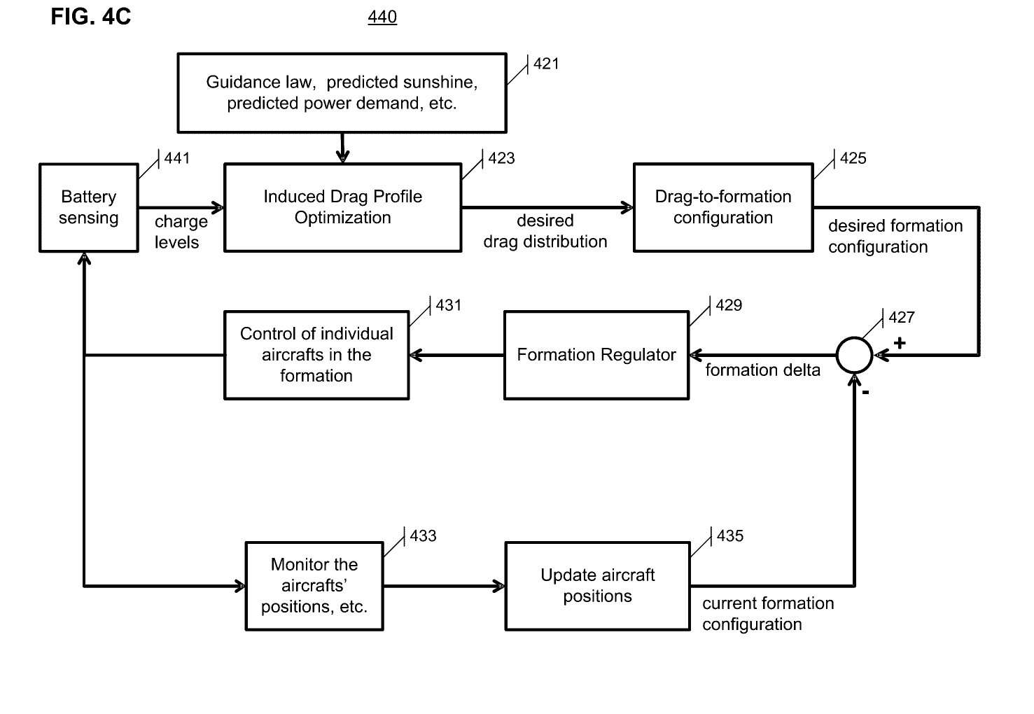

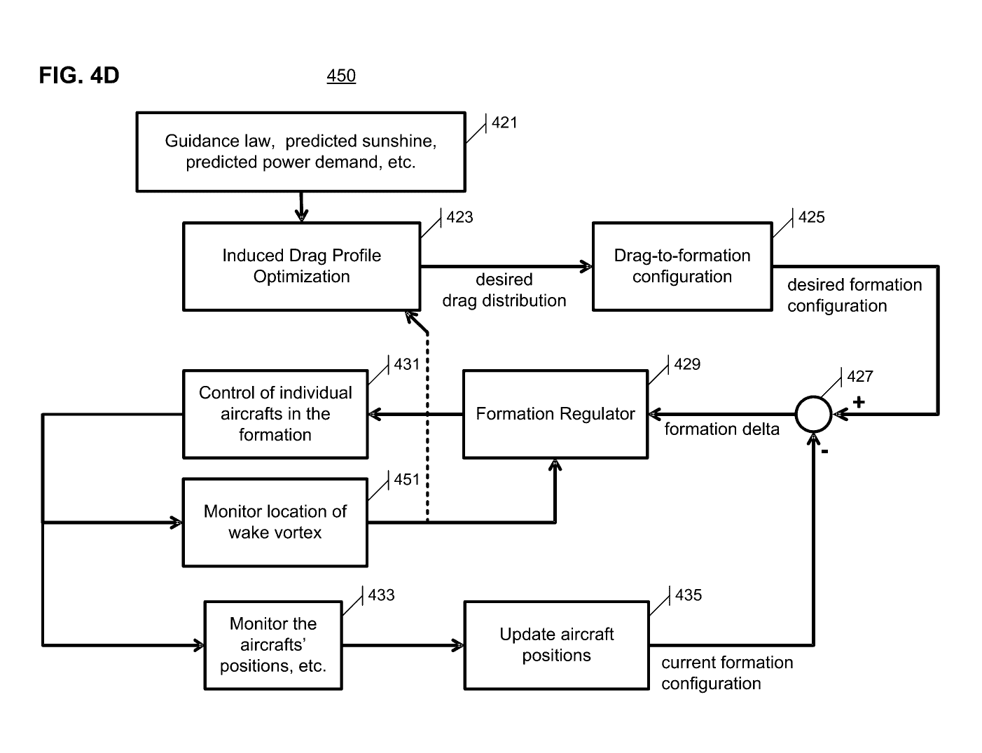

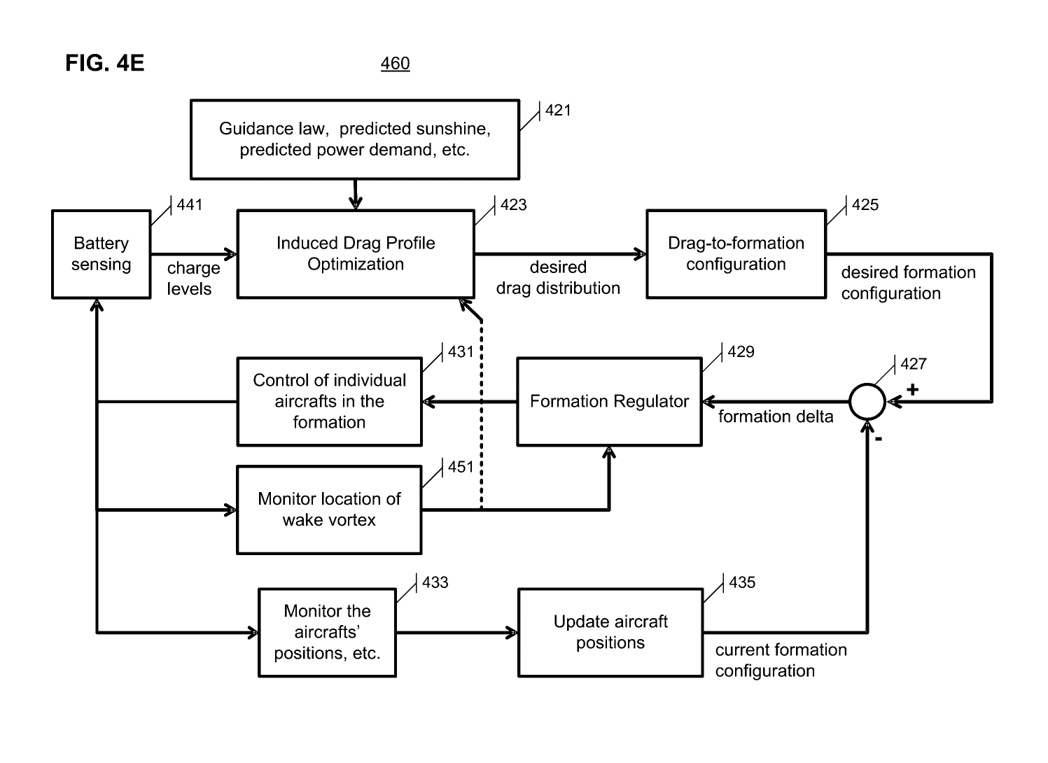

FIGS. 4A-4E are flow diagrams showing various illustrative control methods that may be used by the flight control system 301 to control the inverted-V flight formation of the aircraft system 100.

FIG. 4A shows a general control method 400 that may be used by the flight control system 301. The method 400 begins with step 401 in which the flight control system 301 selects the inverted-V flight formation as the flight formation to be used by the aircraft system 100. The inverted-V flight formation and control characteristics thereof may be selected based on the control instructions 307a stored in the memory 307, for example.

In turn, in step 403, the flight monitor 303 establishes or adjusts the desired flight formation. Specifically, while the inverted-V flight formation has been selected, parameters of the flight formation need to be set. Initially, default parameter values can be used for the flight formation's parameters, including parameter values setting the lateral and longitudinal distances between aircraft (or between individual aircraft's flight paths) in the inverted-V formation. However, in step 403, the parameter values used for the flight formation can be adjusted based on a variety of different variables. An illustrative list of variables that may affect the flight formation parameters include the current operation mode of the aircraft system, environmental conditions, battery charge levels and battery charge rates of individual aircraft (or of the overall aircraft system), the flight path or flight objective of the aircraft system, change in the position of the wake vortex(es) of aircraft in the formation, or the like.

Once the parameter values for the flight formation have been established or adjusted in step 403, control can pass to step 407. However, the flight monitor 303 will continue to continuously monitor the status of the aircraft system, its operating mode, environmental conditions, and other factors to determine whether the flight formation parameters need to be updated. At any time when the flight monitor 303 detects a change or update in system information in step 405, the flight monitor 303 determines whether the parameters for the flight formation need to be updated. If an update is necessary, the flight monitor 303 will trigger step 403 to be performed such that the flight formation parameters can be updated.

In steps 407-413, the flight control system 301 controls the flight of the aircraft in the aircraft system based on the flight formation established in step 403. In step 407, the aircraft monitor 305 monitors the aircraft's relative positions and other aircraft parameters (e.g., velocity, angular velocity, etc.). The monitoring may be performed within one of the aircraft that houses the flight control system 301, or may be performed in each of the aircraft (e.g., by aircraft monitors 305a, 305b, . . . ) with the resulting monitoring data being communicated wirelessly to the flight control system 301. In step 409, the formation monitor 303a determines the current flight formation based on the monitored aircraft positions and parameters. In turn, in step 411, the flight controller 309 compares the current flight formation (determined in step 409) to the desired flight formation (determined in step 403) to determine any deviation, error, or delta. In turn, in step 413, the flight controller 309 controls the individual aircraft to achieve the desired flight formation by driving the deviation, error, or delta to zero. The control of step 407-413 is iteratively performed to maintain the aircraft in formation, and to adjust positions of the aircraft in response to any adjustments to the flight formation (e.g., any adjustments to the flight formation that may be performed in steps 405 and 403, as described above).

While method 400 describes a general method for maintaining the aircraft system in the inverted-V formation, FIG. 4B-4E provide more detailed methods for maintaining the flight formation.

In the method 420 of FIG. 4B, the formation monitor 303a begins by establishing a desired flight formation in steps 421-425. In particular, in step 421, the formation monitor 303a receives from the memory 307 flight formation data 307b. The flight formation data 307b may include data from the plots of FIGS. 2A-2D providing information on induced drag experienced by the aircraft in the formation based on the selected formation and separation distances between aircraft in the formation. More generally, the formation monitor 303a receives information on the control rules and instructions (e.g., 307a) to be used in establishing the desired flight formation. The formation monitor 303a can further receive input from the environmental conditions monitor 303c, the system operating mode monitor 303d, and the turbulence monitor 303e, such as predicted sunshine and other environmental condition information, predicted power demand information, and the like.

In step 423, the formation monitor 303a computes an induced drag profile for the flight formation, and performs optimization to identify a flight formation providing reduced drag. In particular, the formation monitor 303a may determine the best distribution of induced drag for the flight formation given environmental conditions (e.g., wind, sunshine) and mission requirements (e.g., power demands due to climb, descent, or level flight, due to powering a payload, or the like). For example, the trailing aircraft, which may carry a payload, may have greater induced drag by itself due to the weight of the payload, and the flight formation may be selected to offload some drag from the trailing aircraft onto the leading aircraft in order to equalize power expenditure between the aircraft in the formation. In some examples, the formation monitor 303a can take into account the battery states of each aircraft to improve decision-making on induced drag allocation between the aircraft based on available battery resources. Following step 423, the formation monitor 303a has established a desired drag distribution. The desired drag distribution can include a set of desired induced drag weights for each aircraft in the formation, which can take the form of total induced drag values or differences between nominal (solo flight) and desired total induced drag values for each aircraft.

In step 425, the formation monitor 303a determines the desired formation configuration based on the desired drag distribution determined in step 423. Specifically, the formation monitor 303a performs a drag-to-formation configuration in which the monitor determines the requisite positioning of the aircraft in the inverted-V formation to achieve the desired drag distribution. The monitor can determine the configuration based on pre-computed data, can compute the positions of the aircraft in the configuration from equations that have been fitted to data (e.g., fitted to the drag data presented in relation to FIGS. 2A-2D), or can compute the positions of the aircraft in real-time. The desired formation configuration identifies the desired relative positions of the all aircraft in the formation, including values of lateral and longitudinal spacing between the aircraft. In one example, the desired formation is expressed using a coordinate system defined relative to the body axes of the trailing aircraft; in another example, the desired formation is expressed using the coordination system discussed in relation to FIGS. 1A and 1B above.

Once the desired formation configuration is established, the flight controller 309 performs closed-loop control in steps 427-435. In step 427, the flight controller 309 computes the difference between the desired flight formation and the actual current flight formation of the aircraft. For this purpose, the flight controller 309 receives information on the current flight formation and/or the current position of the aircraft in the formation from the flight monitor 303 and/or the aircraft monitor 305. The computed difference corresponds to the difference between the desired and the actual relative positions of the aircraft in the formation, and is referenced as the formation delta in the figure.

In step 429, the flight controller 309 acts as a formation regulator. In this role, the flight controller 309 applies a control law (e.g., forming part of the control instructions 307a stored in memory 307) which seeks to maintain the aircraft in the desired formation and to keep proper spatial separation between the individual aircraft in the formation. In particular, the flight controller 309 takes the formation delta, and determines how each aircraft should be controlled in order to drive the formation delta to a zero value through adjustments to the flight controls of the individual aircraft in the formation. For this purpose, in step 431, the flight controller 309 sends controls to the individual aircraft in the formation (e.g., through aircraft controls 309a, 309b, etc.).

The flight controller 309 performs closed-loop control by further monitoring the aircraft states in response to the controls applied in step 431. As such, in step 433, the aircraft monitor 305 obtains updated information on the aircraft's positions, velocities, operating states, etc. Specifically, updated information is received from the position and rate sensors on each aircraft used to help determine position, speed, acceleration, and other dynamic behavior. The updated information is not limited to position, velocity, acceleration, and angular velocity information for the aircraft in three dimensional space, but can further include information on battery states of charge, rate of battery utilization, battery and solar generation capacity, and the like. The aircraft monitor 305 then computes updated positions of the aircraft in the formation in step 435 based on the available measurements obtained in step 433. The aircraft monitor 305 thereby provides an updated estimate of the aircraft flight formation configuration based at least in part on updated relative positions of the aircraft. Note that the updated positions determined in step 435 may be directly determined based on measurements of the aircraft's relative positions, or may be estimated based on models of the aircraft's dynamics. The updated flight formation configuration is provided to the flight controller 309 for further closed-loop control in step 427.

The method 420 outlined above can be continuously performed to provide real-time closed-loop control of the aircraft in the flight formation. Further, the flight monitor 303 may change or adjust the flight formation or flight path at different times (e.g., in response to changes in environmental conditions, system operating mode, or other factors), and in such situations, the closed-loop control of method 420 can be used to transition the aircraft to the newly adjusted flight formation.

For example, as shown in FIG. 4C, a different method 440 can be used in which the flight formation is adjusted based on the battery levels (and/or charging current levels) in the aircraft of the aircraft system 100. Method 440 is substantially similar to the method 420 described above, and includes an additional step 441 for battery sensing. Step 441 is used to determine the amount of available electrical charge or energy stored in each aircraft (e.g., in batteries in each aircraft), and the step can additionally or alternatively be used to determine charging current levels received from solar panels in each aircraft. Based on the charge level information (and/or charging current level information), the flight monitor 303 may adjust the flight formation in step 423. The adjustment is performed in real-time, such that the flight formation can be adjusted at any point in time. In particular, the flight formation can be adjusted so as to reduce aerodynamic drag on an aircraft having a particularly low charge level (or low charging current). By way of example, longitudinal separation of the trailing aircraft can be increased from a value below 0.8 or 0.9 wingspan to a value over 1.5 wingspans to reduce aerodynamic drag (and battery consumption) experienced by the trailing aircraft if the trailing aircraft's charge level or charging current level is low, in accordance with the teachings of FIG. 2B. Conversely, the longitudinal separation of the trailing aircraft can be decreased from a value over 1.5 wingspans to a value below 0.8 or 0.9 wingspan to reduce aerodynamic drag (and battery consumption) experienced by the leading aircraft if a leading aircraft's charge level or charging current level is low, in accordance with the teachings of FIG. 2B.

In another example shown in FIG. 4D, a further method 450 can be used in which the flight formation regulation is adjusted based on the location of the wake turbulence vortices of the leading aircraft. Method 450 is substantially similar to the method 420 described above, and includes an additional step 451 for monitoring the location of the wake vortices. The monitoring may be performed by the turbulence monitor 303e, and may be used to determine the location of the wingtip vortices trailing from the leading aircraft. The vortex locations may be measured by sensors, but may more generally be modeled by the turbulence monitor 303e using pre-determined models to predict the vortex locations, or determined based on a combination of measuring/sensing and modelling to form a coherent estimate of the vortex locations. As shown in FIG. 4D, the information on the wake vortex obtained through the monitoring of step 451 is used in step 429 by the flight controller to apply the control law and maintain the aircraft in the desired flight formation. Specifically, information on the wake vortices can be used to predict aerodynamic effects on the leading and trailing aircraft due to the effects of the vortices on the aircraft, and to thereby adjust the control input applied to the aircraft in steps 429 and 431 to more accurately maintain the flight formation.

Additionally or alternatively, the information on the wake vortices obtained in step 451 can optionally be used by the flight monitor 303 to adjust the flight formation in step 423, as illustratively shown by the dashed line in FIG. 4D. The adjustment is performed in real-time, such that the flight formation can be adjusted at any point in time so as to take further advantage of the wake vortices to reduce aerodynamic drag on the aircraft of the aircraft system 100. In particular, the flight formation can be adjusted so as to reduce aerodynamic drag on the aircraft by refining the flight formation so as to place the aircraft at appropriate locations relative to the monitored wake vortices.

Finally, FIG. 4E shows an illustrative method 460 in which the additional monitoring of methods 440 and 450 are included. Method 460 is substantially similar to methods 420, 440, and 450, and reference can be made to the descriptions of those methods above for further detailed information.

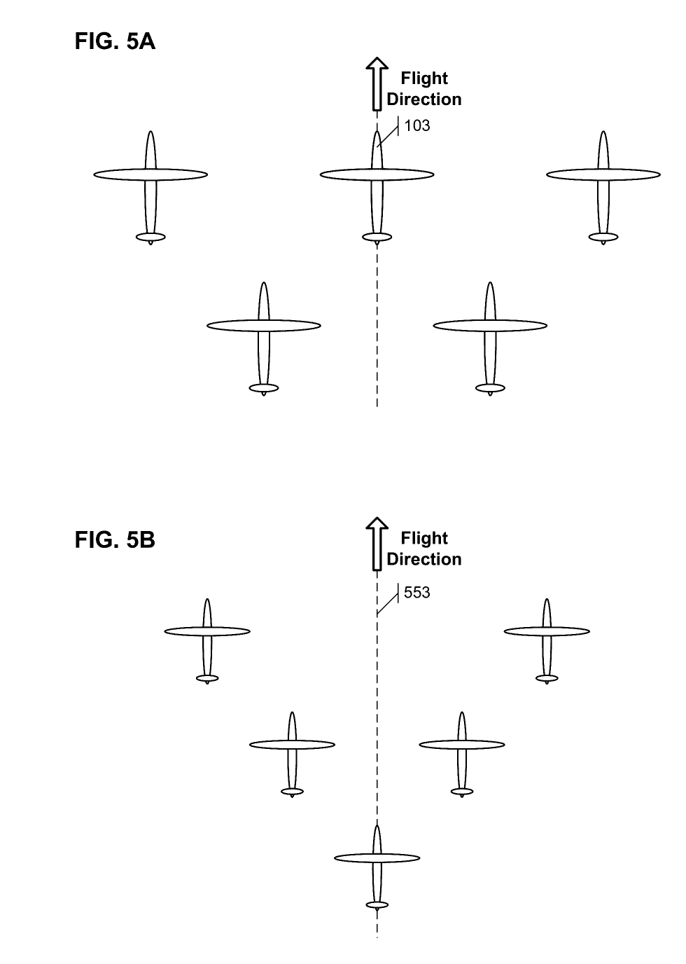

While the discussion above has focused on the illustrative example of aircraft systems that include three aircraft, aircraft systems flying in an inverted-V formation can more generally have three or more aircraft. For example, FIGS. 5A and 5B show illustrative embodiments in which aircraft systems include five aircraft. Other numbers of aircraft, including odd numbers of aircraft (e.g., 7, 9, or 11 aircraft) or even numbers of aircraft (e.g., 4, 6, 8, or 10 aircraft), can also be used.

As shown in FIG. 5A, an aircraft system flying in an inverted-V formation can include five aircraft forming two overlapping and adjacent inverted-V formations (e.g., an inverted-W formation). In the formation shown in FIG. 5A, three leading aircraft are positioned to have substantially identical longitudinal positions, and to be spaced apart from each other by lateral separation distances of approximately 0.95 wingspans (e.g., in the range of [0.8-1.0] or [0.9-1.0] wingspans) between adjacent wingtips. Two trailing aircraft are positioned so as to trail the three leading aircraft, and to each be centered in a respective gap between the three leading aircraft. In general, the trailing aircraft will follow the leading aircraft with a longitudinal spacing of approximately 0.5-2.0 wingspans (e.g., in the range of 0.25-10 wingspans). In the inverted-W formation, each of the trailing aircraft derives an aerodynamic benefit by flying in the wake turbulence of the pair of leading aircraft behind which the trailing aircraft is centered.

In general, in the inverted-W formation, the leading aircraft are identical to each other, and the trailing aircraft are identical to each other. Further, to ensure symmetrical drag on all aircraft, the three leading aircraft have a same longitudinal position, the two trailing aircraft have a same longitudinal position, and the lateral spacing between the two pairs of adjacent leading aircraft is the same.

While FIG. 5A shows an aircraft system including five aircraft, larger numbers of aircraft can also be used by expanding the inverted-W flight formation using any odd-number of aircraft. Further, such aircraft systems may be controlled by a flight control system such as that described in relation to FIG. 3A, in which control instructions and flight formation data are provided for larger numbers of aircraft, and in which aircraft monitors and aircraft controllers are provided to each of the aircraft.

FIG. 5B shows another illustrative aircraft system including five aircraft that form an expanded inverted-V formation. In the expanded inverted-V formation, a three-aircraft inverted-V formation is itself preceded by two additional leading aircraft that are positioned longitudinally ahead of the three-aircraft inverted-V formation, and positioned to have a lateral separation from the flight path 553 that is twice the value of the lateral separation of the leading aircraft in the three-aircraft inverted-V formation. For example, the leading aircraft may be positioned so as to be located at lateral separations of 2*1.0=2.0 wingspans on either side of the flight path 553, or lateral separations of 2*0.95=1.9 wingspans on either side of the flight path 553. Additionally, the leading aircraft may be positioned longitudinally ahead of the trailing aircraft to have a longitudinal separation that is twice the value of the longitudinal separation between the trailing aircraft and the leading aircraft in the three-aircraft inverted-V formation. For example, the leading aircraft may be located 4.0 wingspans ahead of the trailing aircraft, while the intermediate aircraft may be located 2.0 wingspans ahead of the trailing aircraft.

At least some portions of the flight control system 301 may be implemented in or include components of a general-purpose computer that comprises a central processor or other processing device, an internal communication bus, various types of memory or storage media (RAM, ROM, EEPROM, cache memory, disk drives, etc.) for code and data storage, and one or more interfaces for wireless communication. Such portions of the flight control system 301 may include software functionalities implemented in programming and executable code as well as associated stored data, e.g. files used for the establishing, monitoring, and maintaining of an inverted-V flight formation. The software code is executable by the general-purpose computer or processor of the flight control system 301. In operation, the code is stored within the general-purpose computer platform. At other times, however, the software may be stored at other locations and/or transported for loading into the appropriate general-purpose computer system. Execution of such code by a processor of the computer platform enables the platform to implement the flight control methodology in essentially the manner performed in the implementations discussed and illustrated herein.

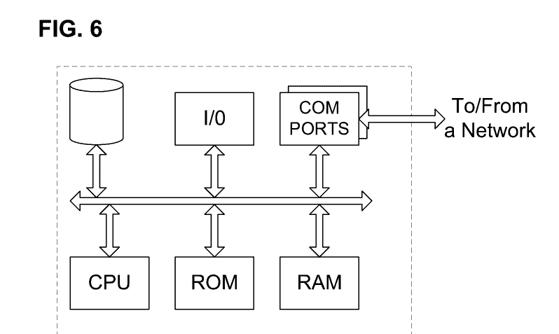

FIG. 6 provides a functional block diagram illustration of a general purpose computer hardware platform. The general purpose computer can optionally include user interface elements (not shown). The computer includes a data communication interface for packet data communication. The computer also includes a central processing unit (CPU), in the form of one or more processors, for executing program instructions. The computer typically includes an internal communication bus, non-transitory program storage and data storage for various data files to be processed and/or communicated by the computer, although the computer often receives programming and data via network communications. Of course, the computing functions may be implemented in a distributed fashion on a number of similar platforms, to distribute the processing load. For example, computing functions can be distributed on processors distributed across multiple aircraft of an aircraft system.

Hence, aspects of the methods of inverted-V flight formation control outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible non-transitory memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a base station into the computer platform of the flight control system. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the flight control systems and methodology shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. An aircraft system comprising:
three aircraft operative to fly independently of each other and including two leading aircraft and a trailing aircraft; and
a flight control system configured to control flight of the three aircraft and maintain the three aircraft in an inverted-V flight formation,
wherein the flight control system controls flight of the three aircraft such that the two leading aircraft fly along parallel flight paths and have substantially identical longitudinal positions along the parallel flight paths, and such that the trailing aircraft flies along a flight path centered between the trailing vortices or flight paths of the two leading aircraft and has a longitudinal position along the flight path that is behind the two leading aircraft.

2. The aircraft system of claim 1, wherein the flight control system controls flight of the three aircraft such that the two leading aircraft maintain a lateral distance between wingtips of 0.8 to 1.0 wingspan of the trailing aircraft.

3. The aircraft system of claim 2, wherein the flight control system controls flight of the three aircraft such that the trailing aircraft has a longitudinal position along the flight path that is between 0 and 10 wingspans behind the two leading aircraft.

4. The aircraft system of claim 1, wherein the flight control system is operative to monitor relative positions of the three aircraft, and to communicate flight control instructions for the three aircraft using wireless communication links between the aircraft.

5. The aircraft system of claim 4, wherein the flight control system is further operative to receive, through the wireless communication links between the aircraft, data on the current status of each aircraft, and to control flight of the three aircraft based at least in part on the received data on the current status of each aircraft.

6. The aircraft system of claim 1, wherein the trailing aircraft has a higher weight than the leading aircraft.

7. The aircraft system of claim 1, wherein the trailing aircraft carries a heavier payload than either of the leading aircraft.

8. The aircraft system of claim 1, further comprising:
fourth and fifth aircraft operative to fly independently of each other and of the three aircraft,
wherein the flight control system is further configured to control flight of the fourth and fifth aircraft, and
wherein the flight control system controls flight of the fourth and fifth aircraft such that the fourth and fifth aircraft fly along respective flight paths that are parallel to the flight paths of the two leading aircraft.

9. The aircraft system of claim 8,
wherein the flight control system controls flight of the fourth and fifth aircraft such that the fourth aircraft has a longitudinal position along its respective flight path that is identical to the longitudinal position of the two leading aircraft and such that the fifth aircraft has a longitudinal position along its respective flight path that is identical to the longitudinal position of the trailing aircraft.

10. The aircraft system of claim 8,
wherein the flight control system controls flight of the fourth and fifth aircraft such that the fourth and fifth aircraft have a same longitudinal position that is ahead of the two leading aircraft, and the flight paths of the fourth and fifth aircraft are disposed symmetrically about the flight path of the trailing aircraft.

11. A method comprising:
receiving, in a flight control system operative to control flight of an aircraft system including at least three aircraft, relative position measurements of the at least three aircraft; and
controlling flight of the at least three aircraft based on the received relative position measurements so as to maintain the three aircraft in an inverted-V flight formation by controlling two leading aircraft of the at least three aircraft to fly along parallel flight paths and have substantially identical longitudinal positions along the parallel flight paths, and controlling a trailing aircraft of the at least three aircraft to fly along a flight path centered between the trailing vortices or flight paths of the two leading aircraft and have a longitudinal position along the flight path that is behind the two leading aircraft.

12. The method of claim 11, wherein the controlling comprises communicating, from the flight control system through wireless communication links between the aircraft, flight control instructions for the three aircraft.

13. The method of claim 11, wherein the controlling comprises controlling the flight of the at least three aircraft such that the two leading aircraft maintain a lateral distance between wingtips of 0.8 to 1.0 wingspan of the trailing aircraft.

14. The method of claim 13, wherein the controlling further comprises controlling the flight of the at least three aircraft such that trailing aircraft has a longitudinal position along the flight path that is between 0 and 10 wingspans behind the two leading aircraft.

15. The method of claim 11, further comprising:
changing an inter-aircraft spacing parameter of the inverted-V flight formation; and
controlling flight of the at least three aircraft so as to place the three aircraft in the inverted-V flight formation having the changed inter-aircraft spacing parameter.

16. The method of claim 15, wherein the inter-aircraft spacing parameter is changed based on determining a change in an operating mode of the aircraft system, a change in environmental conditions affecting the aircraft system, a change in a battery charge level or rate of the aircraft system, or a change in a flight path or objective of the aircraft system.

17. The method of claim 15, wherein the changing of the inter-aircraft spacing parameter comprises reducing a longitudinal spacing between the leading aircrafts and the trailing aircrafts to a spacing of less than 4.0 wingspans of the trailing aircraft.

18. The method of claim 15, wherein the changing of the inter-aircraft spacing parameter comprises increasing a longitudinal spacing between the leading aircraft and the trailing aircraft in response to entering an operating mode in which a payload of the trailing aircraft is active.

19. A flight control system configured to control flight of three aircraft operative to fly independently of each other and to maintain the three aircraft in an inverted-V flight formation, the flight control system comprising:
an aircraft monitor receiving relative position measurements of the three aircraft;
a flight formation monitor determining inter-aircraft spacing parameters of a desired inverted-V flight formation for the three aircraft; and
a flight controller controlling flight of the three aircraft based on the relative position measurements received by the aircraft monitor so as to maintain the three aircraft in the desired inverted-V flight formation determined by the flight formation monitor by controlling two leading aircraft of the three aircraft to fly along parallel flight paths and have substantially identical longitudinal positions along the parallel flight paths, and controlling a trailing aircraft of the three aircraft to fly along a flight path centered between the trailing vortices or flight paths of the two leading aircraft and have a longitudinal position along the flight path that is behind the two leading aircraft.

20. The flight control system of claim 19, wherein the flight formation monitor determines a lateral inter-aircraft spacing parameter between wingtips of the two leading aircraft of 0.8 to 1.0 wingspan of the trailing aircraft for the desired inverted-V flight formation for the three aircraft.
